(19) United States
(12) Patent Application Publication
(10) Pub. No.: US 2003/0137624 A1
(43) Pub. Date: Jul. 24, 2003

(54) Reflective liquid crystal display and projection system including the same

(76) Inventors: Seung-Gon Kang, Kyungki-do (KR); Sung-Tae Kim, Seoul (KR)

Correspondence Address: Robert E. Bushnell, Suite 300, 1522 K Street, N.W., Washington, DC, 20005, US

(21) Appl. No.: 10/242,396

(22) Filed: Sep. 13, 2002

(30) Foreign Application Priority Data
Jan. 21, 2002 (KR) 2002-3342

(51) Int. Cl. G02F 1/1335

(52) U.S. Cl. 349/113

(57) ABSTRACT

The present invention provides a reflective liquid crystal display including a semiconductor lower substrate having a plurality of thin film transistors, a plurality of reflective electrodes electrically connected to each thin film transistor, a transparent upper substrate provided opposing the semiconductor lower substrate, a common transparent electrode formed on the upper substrate, the common transparent electrode forming pixels together with the reflective electrodes, and a liquid crystal layer formed between the semiconductor lower substrate and the upper substrate, with the following conditions are satisfied by the reflective liquid crystal display:

0.15≦(Δn*d)_{LC}(μm)≦0.25,

0.10≦Δn≦0.28,

where (Δn*d)_{LC} is a retardation of the reflective liquid crystal display, Δn is a difference between a refractive index of long axes of liquid crystals and a refractive index of short axes of liquid crystals, and d is a cell gap of the reflective liquid crystal display.

This application makes reference to, incorporates the same herein, and claims all benefits accruing under 35 U.S.C. §119 from my application REFLECTIVE LIQUID CRYSTAL DISPLAY AND PROJECTION SYSTEM INCLUDING THE SAME filed with the Korean Industrial Property Office on Jan. 21, 2002 and there duly assigned Serial No. 2002-3342.

### BACKGROUND OF THE INVENTION

1. Technical Field

The present invention relates to a reflective liquid crystal display and, more particularly, to a reflective liquid crystal display referred to as a liquid crystal on silicon (LCOS) display, in which liquid crystal cells are formed on a semiconductor substrate. The present invention also relates to a projection system including the reflective liquid crystal display.

2. Related Art

In a liquid crystal on silicon (LCOS) display, structural elements of each pixel and switching circuits are arranged in a highly integrated manner such that high resolutions of extended graphics array (XGA) class and higher are realized in small sizes of approximately one inch. As a result of the small size and high resolution characteristics, the liquid crystal on silicon (LCOS) display is suitable for use as a projection system display, in which an optical lens system is used to enlarge and project display images.

The different types of projection systems using the liquid crystal on silicon (LCOS) display include the 3-panel type projection system in which three liquid crystal on silicon (LCOS) displays are included that correspond to red (R), green (G), and blue (B) light, and red (R), green (G), and blue (B) images realized by each of the liquid crystal on silicon (LCOS) displays are combined into a single image; and the 1-panel type projection system in which white light emitted from a light source is sequentially converted into red (R), green (G), and blue (B) light, and a single liquid crystal on silicon (LCOS) display is driven using a system of time-sharing.

In the projection system using a liquid crystal on silicon (LCOS) display, it is necessary that response times of liquid crystals are short in order to realize natural moving images. In particular, since the single liquid crystal on silicon (LCOS) display is driven using a time-sharing system in the 1-panel type projection system, it is necessary that the liquid crystal on silicon (LCOS) display have a response time of 1 millisecond (ms) or less.

As a result, to reduce the response time of liquid crystals, a cell gap of the liquid crystal on silicon (LCOS) display must be made small. However, if the cell gap changes, a retardation of the liquid crystal on silicon (LCOS) display also changes. In the liquid crystal on silicon (LCOS) display, the retardation is Δn*d, where Δn is a difference between a refractive index of long axes of liquid crystals and a refractive index of short axes of liquid crystals, and d is the LCOS cell gap. The retardation is an important factor that determines a contrast ratio of the screen and the response time of liquid crystals.

Accordingly, in a state where the retardation is at a fixed measurement, a reduction in only the cell gap (d) of the liquid crystal on silicon (LCOS) display results in an increase in the refractive index difference (Δn). Since the refractive index difference (Δn) is typically directly proportional to a viscosity of the liquid crystals, an increase in the refractive index difference (Δn) results in an increase in the viscosity of the liquid crystals, which, in turn, negatively affects high-speed responsiveness characteristics of liquid crystals.

Therefore, for the projection system using the liquid crystal on silicon (LCOS) display, and in particular, the 1-panel type projection system, in order to realize the display of moving images, there is a need for a liquid crystal on silicon (LCOS) display that maintains a low refractive index difference (Δn) in order to decrease the viscosity of liquid crystals while establishing a low retardation to enable high speed responsiveness of liquid crystals by the reduction in the cell gap (d).

Further, there is a need for a projection system that optimally establishes optical conditions of each structural element of the projection system in correspondence to a liquid crystal on silicon (LCOS) having a new retardation such that exceptional picture quality is maintained.

Exemplars of recent efforts relating to liquid crystal displays include U.S. Pat. No. 5,592,288 to Sampica et al., entitled METHOD AND APPARATUS FOR PRE-ASSEMBLING OPTICAL COMPONENTS FOR USE WITH LIQUID CRYSTAL DISPLAYS, issued on Jan. 7, 1997, U.S. Pat. No. 5,619,352 to Koch et al., entitled LCD SPLAY/TWIST COMPENSATOR HAVING VARYING TILT AND/OR AZIMUTHAL ANGLES FOR IMPROVED GRAY SCALE PERFORMANCE, issued on Apr. 8, 1997, U.S. Pat. No. 6,262,788 to Hanrahan et al., entitled PROCESS FOR PREPARING AN OPTICAL RETARDATION FILM, issued on Jul. 17, 2001, U.S. Pat. No. 6,266,114 to Skarohlid, entitled METHOD AND APPARATUS FOR COMPENSATING A LIQUID CRYSTAL DISPLAY, issued on Jul. 24, 2001, U.S. Pat. No. 5,963,289 to Stefanov et al., entitled ASYMMETRICAL SCRIBE AND SEPARATION METHOD OF MANUFACTURING LIQUID CRYSTAL DEVICES ON SILICON WAFERS, issued on Oct. 5, 1999, U.S. Pat. No. 5,933,207 to Wu, entitled REFLECTIVE-TYPE LIQUID CRYSTAL DISPLAYS USING MIXED-MODE TWIST NEMATIC CELLS, issued on Aug. 3, 1999, and U.S. Pat. No. 5,969,785 to Wu, entitled REFLECTIVE-TYPE LIQUID CRYSTAL DISPLAY USING POLARIZER FREE MIXED-MODE TWIST NEMATIC CELLS WITH DICHROIC DYE, issued on Oct. 19, 1999.

While these recent efforts provide advantages, we note that they fail to adequately provide an improved reflective liquid crystal display and projection system including the same.

### SUMMARY OF THE INVENTION

It is one object of the present invention to provide a reflective liquid crystal display that enables high speed responsiveness of 1 millisecond (ms) or less through control of liquid crystal retardation such that a projection system having a liquid crystal on silicon (LCOS) display, particularly a 1-panel type projection system, can effectively realize moving images.

It is another object of the present invention to provide a projection system that optimally establishes optical conditions of each structural element of the projection system in correspondence to a liquid crystal on silicon (LCOS) display having a new retardation such that exceptional picture quality is maintained.

To achieve the above objects and others, the present invention provides a reflective liquid crystal display including a semiconductor lower substrate including a plurality of thin film transistors; a plurality of reflective electrodes electrically connected to each of the thin film transistors; a transparent upper substrate provided opposing the semiconductor lower substrate; a common transparent electrode formed on a surface of the upper substrate opposing the reflective electrodes, the common transparent electrode forming pixels together with the reflective electrodes; and a liquid crystal layer formed between the semiconductor lower substrate and the upper substrate, wherein the following conditions are satisfied by the reflective liquid crystal display:

0.15≦(Δn*d)_{LC}(μm)≦0.25, 0.10≦Δn≦0.28,

where Δn is a difference between a refractive index of long axes of liquid crystals and a refractive index of short axes of liquid crystals, and d is a cell gap of the reflective liquid crystal display.

The present invention also provides a projection system including a light converter sequentially converting white light emitted from a light source into first, second, and third light; a polarizing beam splitter separating received light into S-polarized light and P-polarized light; a reflective liquid crystal display receiving the polarized light from the polarizing beam splitter and II driving liquid crystals for each pixel to realize the display of images; a polarizing plate mounted in a path of light to selectively transmit light of a specific polarizing axis; a λ/4-plate mounted between the polarizing beam splitter and the reflective liquid crystal display to remove elliptical polarization of the polarized light; and a retardation film mounted to one surface of the λ/4-plate, the retardation film compensating a refractive index dispersion according to a wavelength of liquid crystals, wherein the reflective liquid crystal display satisfies the following conditions:

0.15≦(Δn*d)_{LC}(μm)≦0.25, 0.10≦Δn≦0.28,

where (Δn*d)_{LC} indicates a retardation of the reflective liquid crystal display, Δn is a difference between a refractive index of long axes of liquid crystals and a refractive index of short axes of liquid crystals, and d is a cell gap of the reflective liquid crystal display.

Preferably, the reflective liquid crystal display includes nematic liquid crystals having a twist angle of 0˜80°, and an angle between a polarizing axis of the polarizing plate and a rubbing axis of the liquid crystals is in the range of 0˜50° or 110˜170°. The term “nematic” relates to the phase of a liquid crystal characterized by arrangement of the long axes of the molecules in parallel lines but not layers.

Further, the λ/4-plate is realized through a wideband λ/4-plate that removes elliptical polarization of polarized light in the visible ray wavelength range, the retardation film has a retardation in the range of 0.01˜0.2 micrometers (μm), and an optical axis angle of the retardation film is in the range of 0˜180°.

To achieve these and other objects in accordance with the principles of the present invention, as embodied and broadly described, the present invention provides a reflective liquid crystal display, comprising: a semiconductor lower substrate; a plurality of thin film transistors being included in said lower substrate; a plurality of reflective electrodes being electrically connected to each of said transistors; a transparent upper substrate opposing said lower substrate; a plurality of common transparent electrodes being formed on a surface of said upper substrate opposing said reflective electrodes, said transparent electrodes forming pixels together with said reflective electrodes; and a liquid crystal layer being formed between said lower substrate and said upper substrate, the following conditions being satisfied by the reflective liquid crystal display:

0.15≦(Δn*d)_{LC}(μm)≦0.25,

0.10≦Δn≦0.28,

where Δn is a difference between a refractive index of long axes of the liquid crystals of the liquid crystal layer and a refractive index of short axes of the liquid crystals of the liquid crystal layer, and where d is a cell gap of the reflective liquid crystal display.

To achieve these and other objects in accordance with the principles of the present invention, as embodied and broadly described, the present invention provides a projection system, comprising: a light converter sequentially converting white light emitted from a light source into first, second, and third light; a polarizing beam splitter separating received light into S-polarized light and P-polarized light; a reflective liquid crystal display including liquid crystals, said reflective liquid crystal display receiving the polarized light from said polarizing beam splitter, said reflective liquid crystal display driving the liquid crystals for each pixel to display images; a polarizing plate being mounted in a path of the polarized light, said polarizing plate selectively transmitting light of a specific polarizing axis; a λ/4-plate being mounted between said polarizing beam splitter and said reflective liquid crystal display, said λ/4-plate removing elliptical polarization of the polarized light; and a retardation film being mounted to one surface of said λ/4-plate, said retardation film compensating a refractive index dispersion according to a wavelength of the liquid crystals, said reflective liquid crystal display satisfying the following conditions:

0.15≦(Δn*d)_{LC}(μm)≦0.25,

0.10≦Δn≦0.28,

where (Δn*d)_{LC} indicates a retardation of said reflective liquid crystal display, where Δn is a difference between a refractive index of long axes of the liquid crystals and a refractive index of short axes of the liquid crystals, and where d is a cell gap of said reflective liquid crystal display.

To achieve these and other objects in accordance with the principles of the present invention, as embodied and broadly described, the present invention provides a projection system, comprising: a polarizing beam splitter separating received light into S-polarized light and P-polarized light; a reflective liquid crystal display including liquid crystals, said reflective liquid crystal display receiving the polarized light from said polarizing beam splitter, said reflective liquid crystal display driving the liquid crystals for each pixel to display images; a λ/4-plate being mounted between said polarizing beam splitter and said reflective liquid crystal display, said λ/4-plate removing elliptical polarization of the polarized light; and a retardation film being mounted to one surface of said λ/4-plate, said retardation film compensating a refractive index dispersion according to a wavelength of the liquid crystals, said reflective liquid crystal display satisfying the following conditions:

0.15≦(Δn*d)_{LC}(μm)≦0.25,

0.10≦Δn≦0.28,

where (Δn*d)_{LC} indicates a retardation of said reflective liquid crystal display, where Δn is a difference between a refractive index of long axes of the liquid crystals and a refractive index of short axes of the liquid crystals, and where d is a cell gap of said reflective liquid crystal display.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a sectional view of a reflective liquid crystal display, in accordance with the principles of a preferred embodiment of the present invention;

FIG. 2 is a partially enlarged view of a semiconductor lower substrate shown in FIG. 1;

FIG. 3 is a schematic view of a projection system, in accordance with the principles of a preferred embodiment of the present invention;

FIG. 4 is a reflectance/voltage curve diagram of the projection system of FIG. 3; and

FIGS. 5 to 8 are reflectance/voltage curve diagrams of projection systems of comparative examples.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Preferred embodiments of the present invention will now be described in detail with reference to the accompanying drawings.

In a liquid crystal on silicon (LCOS) display, the retardation can be maintained at approximately 0.4˜0.9 micrometers (μm). Advantages can be realized when the retardation of a liquid crystal on silicon display is lowered.

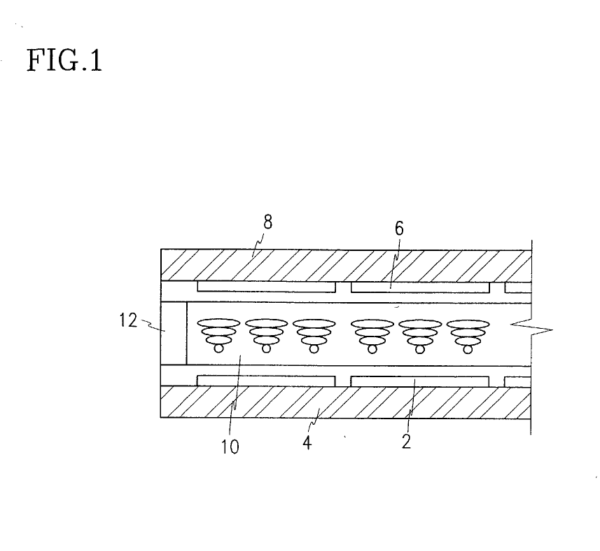

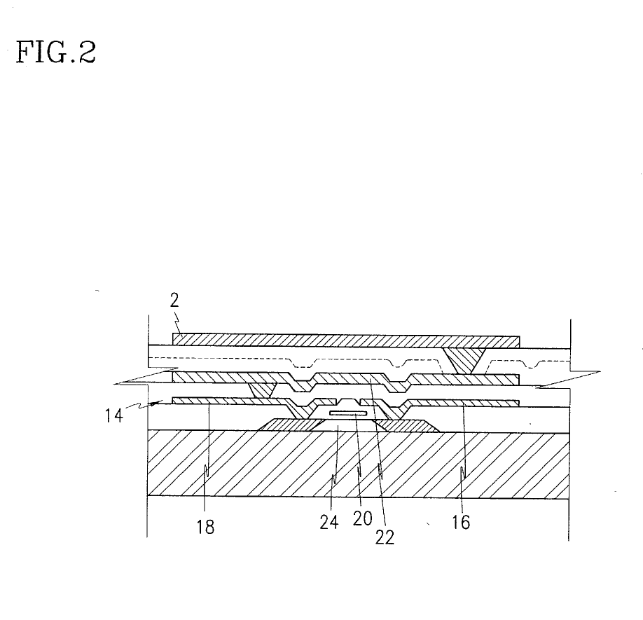

FIG. 1 is a sectional view of a reflective liquid crystal display (hereinafter referred to as a liquid crystal on silicon display) according to a preferred embodiment of the present invention, and FIG. 2 is a partially enlarged view of a semiconductor lower substrate shown in FIG. 1 and is used to describe thin film transistor.

With reference to the drawings, the liquid crystal on silicon (LCOS) display includes a semiconductor lower substrate 4 having a plurality of reflective electrodes 2, a transparent upper substrate 8 having a common transparent electrode 6, and a sealant 12 for integrally joining the semiconductor lower substrate 4 and the upper substrate 8 with a liquid crystal layer 10 interposed therebetween. The reflective electrodes 2 are made of highly reflective metal such as aluminum, and the transparent electrode 6 is made of a transparent conductive film such as an indium tin oxide (ITO) film.

Generally, the reflective electrodes 2, which form pixels, are 11.4×11.4 μm in size. Variations in the alignment of liquid crystal molecules are realized by the difference in voltages applied to the reflective electrodes 2 and the transparent electrode 6 such that a light transmissivity of each pixel is varied. In particular, each of the reflective electrodes 2, with reference to FIG. 2, is connected to a thin film transistor 14 to receive a current for the control of liquid crystals.

In more detail and using the single thin film transistor 14 in FIG. 2 as an example, each of the thin film transistors 14 includes a source 16, a drain 18, and a gate 20 provided between the source 16 and the drain 18. The drain 18 is connected to the reflective electrode 2 by a connecting electrode 22, and a capacitor 24 is mounted under the gate 20, that is, between the gate 20 and the semiconductor lower substrate 4. The source 16, drain 18, gate 20, and capacitor 24 are separated by an insulating layer so that these elements do not contact each other.

In the liquid crystal on silicon (LCOS) display according the preferred embodiment of the present invention, a retardation of the liquid crystal layer 10 is such that the following Equation 1 is satisfied to thereby reduce a response time of liquid crystals.

0.15≦(×n*d)_{LC}(μm)≦0.25 [Equation 1]

The retardation of the liquid crystal layer 10 is Δn*d. Note that Δn is a difference between a refractive index of long axes of the liquid crystals in the liquid crystal layer and a refractive index of short axes of the liquid crystals in the liquid crystal layer. Note that d is a cell gap of the liquid crystal on silicon (LCOS) display.

Establishing the retardation of the liquid crystal layer 10 in a low range enables high speed responsiveness of liquid crystals according to reductions in the cell gap (d). In the preferred embodiment of the present invention, the cell gap (d) of the LCOS display is 1 μm or less. The refractive index difference (Δn) is established satisfying the following Equation 2 such that increases in liquid crystal viscosity by increases in the refractive index difference (Δn) are minimized.

0.10≦Δn≦0.28 [Equation 2]

Preferably, the liquid crystal layer 10 is realized through nematic liquid crystals that satisfy both of the above equations. A characteristic of nematic liquid crystals is that they can be driven at a low voltage of 5 volts (V) or less.

By reducing the cell gap (d) and setting the refractive index difference (Δn) at a low range, the response time of liquid crystals is reduced to roughly 0.6 milliseconds (ms) to thereby obtain high speed responsiveness characteristics. Further, if the cell gap (d) is reduced, since the influence of drive electrical fields between pixels is reduced, a fringe field effect, which is caused by electric field variations between pixels, is minimized.

Accordingly, the liquid crystal on silicon (LCOS) display of the preferred embodiment of the present invention is suitable for use in a projection system, and particularly in a 1-panel type projection system that drives a single liquid crystal on silicon (LCOS) display using a time sharing format.

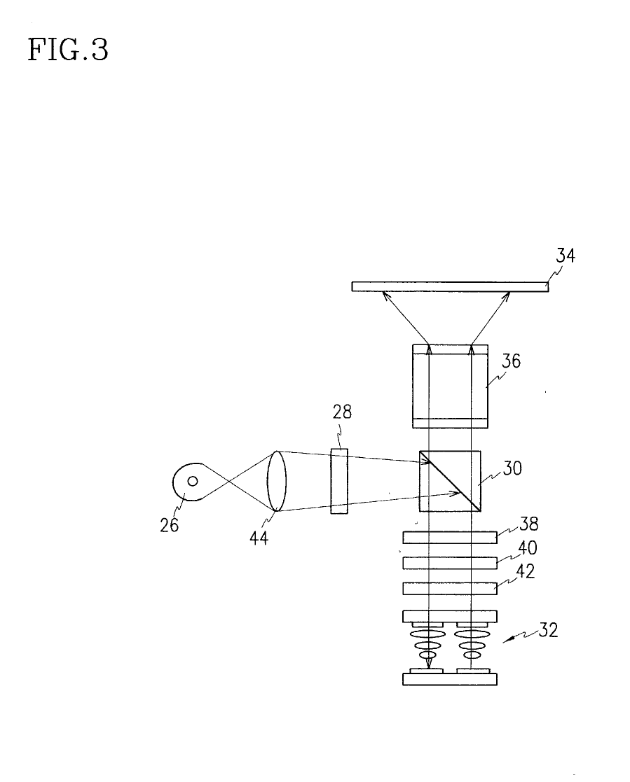

FIG. 3 is a schematic view of a projection system according to a preferred embodiment of the present invention. The projection system includes a light source 26 for emitting a white light; a light converter 28 for sequentially converting the white light into R, G, and B light; a polarizing beam splitter (PBS) 30 that separates received light into S-polarized light and P-polarized light; a liquid crystal on silicon (LCOS) display 32 receiving the S-polarized light and driving liquid crystals for each pixel; and a projection lens system 36 enlarging and projecting an image realized by the liquid crystal on silicon (LCOS) display 32 onto a screen 34. Further, a wideband λ/4-plate 38, a retardation film 40, and a polarizing plate 42 are positioned between the polarizing beam splitter (PBS) 30 and the liquid crystal on silicon (LCOS) display 32. The normal conventions for polarization are followed here, with the polarization direction of S-polarized light being orthogonal to the polarization direction of P-polarized light.

The light converter 28, for which a conventional color switch or a color wheel can be used, sequentially converts white light into R, G, and B light as described above, and provides the converted light to the polarizing beam splitter (PBS) 30. The polarizing beam splitter (PBS) 30 reflects, among the received light, S-polarized light and allows the transmission of P-polarized light to thereby act as a right-angled polarizing plate.

However, in other 1-panel type projection systems, light passing through the light converter 28 enters the PBS 30 in a state having a predetermined angle as a result of a focusing lens 44 such that the S-polarized light separated in the polarizing beam splitter (PBS) 30 is elliptically polarized, thereby reducing a light utilization efficiency. Therefore, the wideband λ/4-plate 38 compensates a polarization of light passing through the PBS 30 such that completely S-polarized light is supplied to the liquid crystal on silicon (LCOS) display 32.

Accordingly, in the preferred embodiment of the present invention, a contrast of a screen is improved by approximately two to three times compared to a projection system that does not include the wideband λ/4-plate 38. The wideband λ/4-plate 38 is such that it has the same λ/4-plate function in the visible ray wavelength range that includes all R, G, and B light. The visible ray wavelength range is approximately 400˜700 nanometers (nm).

Further, the liquid crystal on silicon (LCOS) display includes nematic liquid crystals that satisfy the conditions as set forth by Equations 1 and 2 such that high speed responsiveness of liquid crystals is realized. The liquid crystal on silicon (LCOS) display also satisfies the conditions outlined in Table 1 below.

TABLE 1

| Liquid crystal twist angle | 0˜80° |
|---|---|
| Angle between polarizing axis of | 0˜50° or 100˜170° |
| polarizing plate and rubbing axis of liquid | |
| crystals | |

Further, the retardation film 40 compensates a refractive index dispersion according to a wavelength of liquid crystals such that light emitted from the liquid crystal on silicon (LCOS) display 32 after passing through liquid crystals two times exhibits almost identical electro-optical characteristics in the visible ray wavelength range.

That is, the retardation film 40 functions such that the liquid crystal on silicon (LCOS) display 32 shows the same reflectance change appearance with respect to light of each R, G, and B wavelength according to changes in voltage. Preferably, the retardation film 40 satisfies the optical conditions outlined in Table 2 below.

TABLE 2

| Retardation (Δn*d)_{RF} | 0.01˜0.2 μm |
|---|---|
| Optical axis angle | 0˜180° |

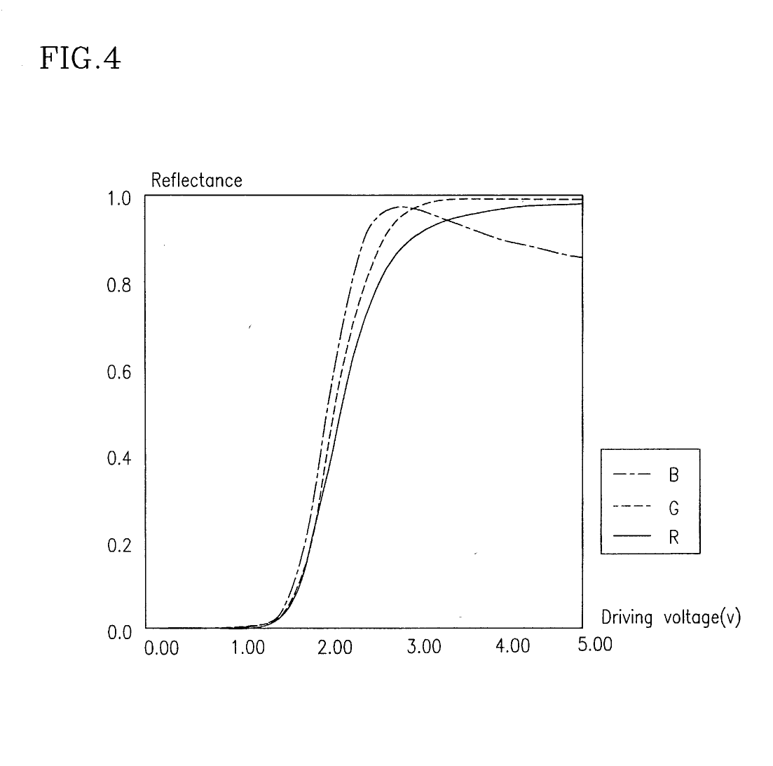

FIG. 4 is an R-V (Reflectance-Voltage) curve diagram of the projection system according to the preferred embodiment of the present invention. Optical conditions to obtain the results of FIG. 4 are as shown in Table 3 below.

TABLE 3

| LCOS display retardation (Δn*d)_{LC} | 0.189 μm |
|---|---|
| Twist angle of liquid crystals | 45° |
| Angle between polarizing axis of | 18° |
| polarizing plate and rubbing axis of liquid | |
| crystals | |
| Retardation of retardation film (Δn*d)_{RF} | 0.16 μm |
| Optical axis angle of retardation film | 135° |

As shown in FIG. 4, in the case where all the conditions of Equations 1 and 2, and of Tables 1 and 2 are satisfied, black states in the R, G, and B light coincide, and the R-V curves of the R, G, and B light display almost identical variation tendencies.

When nearly identical R-V curves with respect to each R, G, and B wavelength occur, application to a 1-panel type projection system is possible and excellent picture quality is realized.

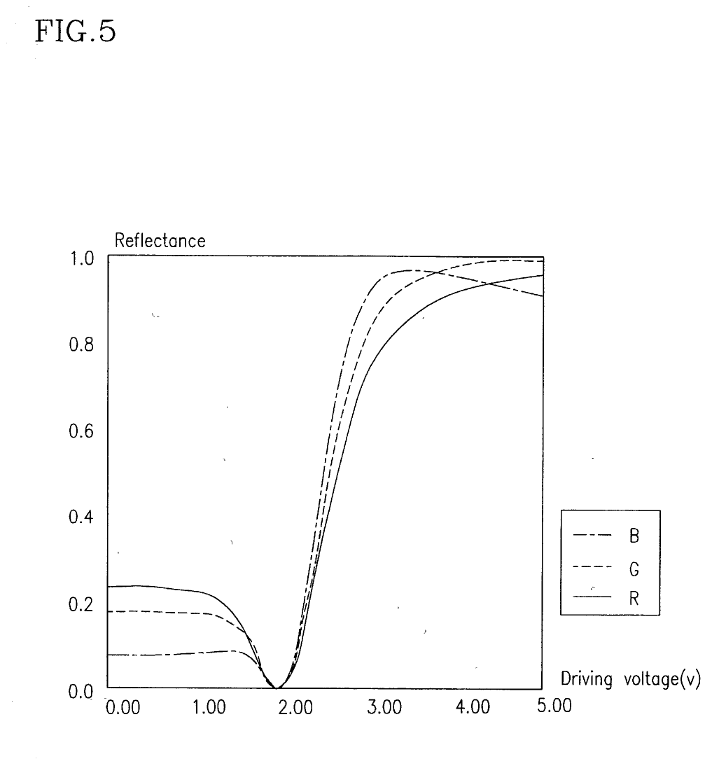

FIG. 5 shows R-V curves in the case where the liquid crystal on silicon (LCOS) display retardation value in Table 3 is changed to 0.28 micrometers (μm). In a black state where a voltage is low, the R-V curves for the R, G, and B light show marked differences. This indicates that if the liquid crystal on silicon (LCOS) display retardation value does not satisfy the condition of Equation 1, picture characteristics and contrast deteriorate in a black state.

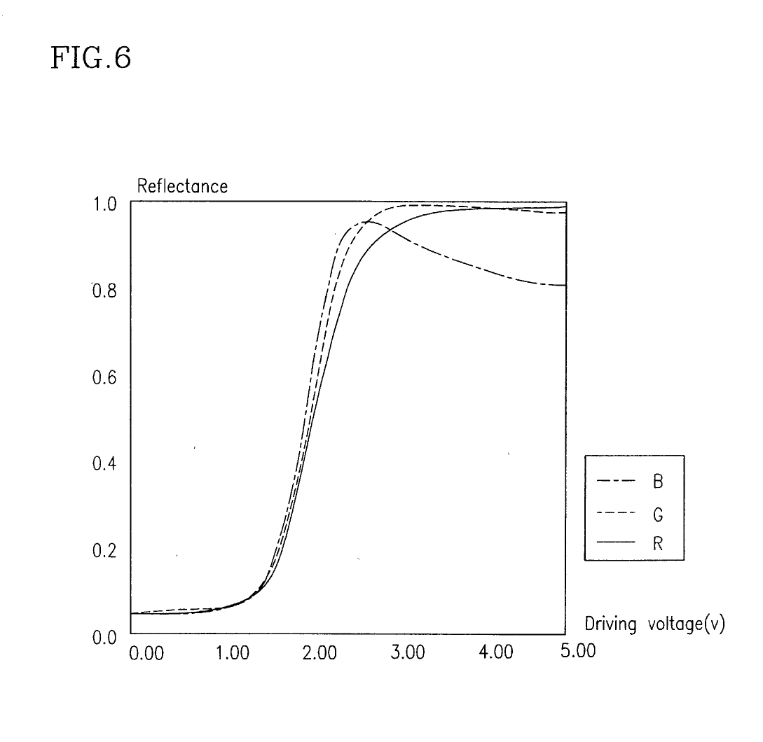

FIG. 6 shows R-V curves in the case where the twist angle of liquid crystals is changed to 85° from the value shown in Table 3. As shown in the drawing, in a black state where the voltage is low, a dark level increases such a fully black state is not realized. This indicates that if the twist angle of liquid crystals does not satisfy the condition of Equation 1, picture characteristics and contrast deteriorate in a black state.

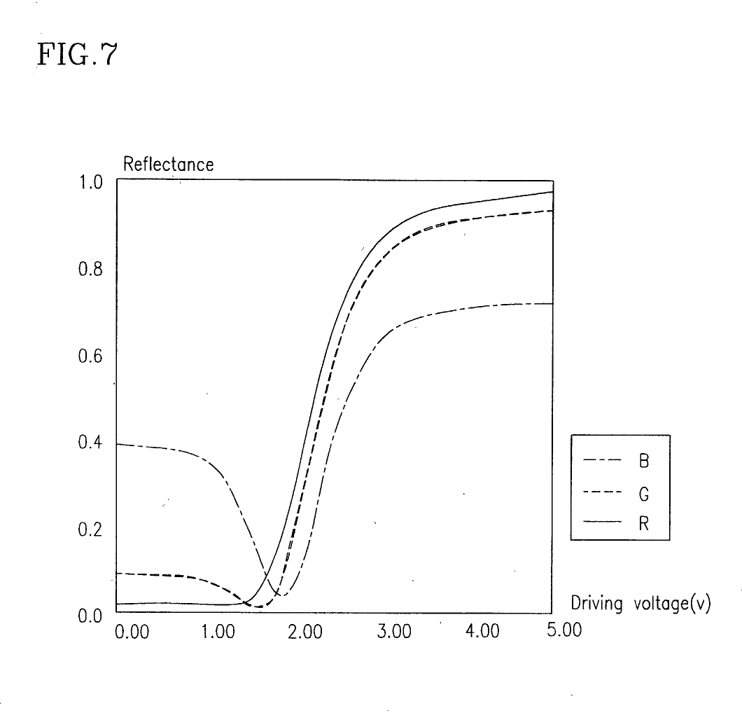

FIG. 7 shows R-V curves in the case where the angle between the polarizing axis of a polarizing plate and the rubbing axis of liquid crystals is changed to 60° from the value shown in Table 3. As shown in the drawing, in both a white state where the voltage is high and in a black state where the voltage is low, the R-V curves for the R, G, and B light are significantly different. As a result, if there are significant differences in the R-V curves, application to a 1-panel type projection system is not possible.

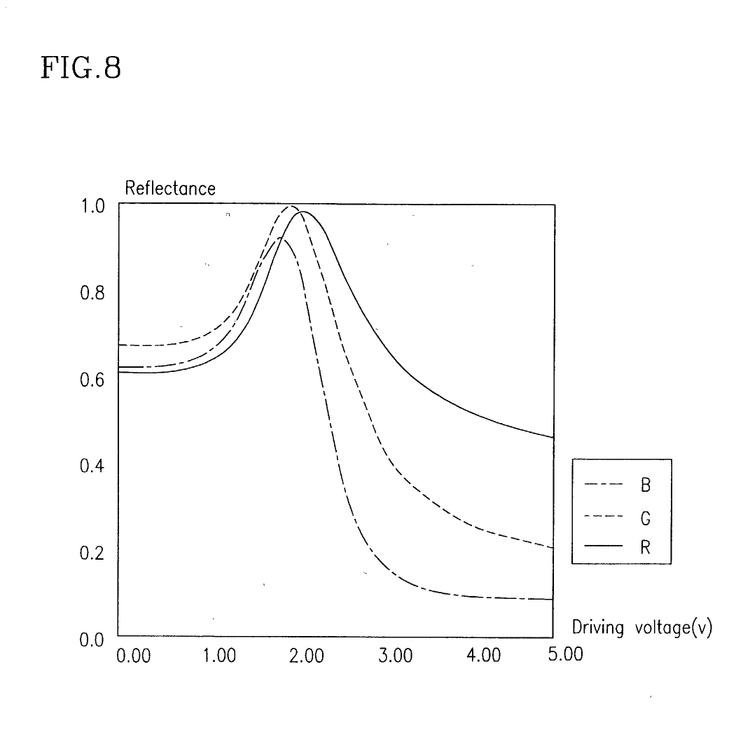

FIG. 8 shows R-V curves in the case where the retardation of the retardation film is changed to 0.25 micrometers (μm) from the value shown in Table 3. As shown in the drawing, there are substantial differences in the R-V curves for the R, G, and B light. Therefore, if the retardation value of the retardation film does not satisfy the conditions of Table 2, since the desired R-V curve characteristics cannot be satisfied, application to a 1-panel type projection system is not possible.

In the present invention described above, high speed responsiveness of liquid crystals is possible through retardation control of a reflective liquid crystal display. Accordingly, the reflective liquid crystals display of the present invention is suitable for use in projection system, and particularly a 1-panel type projection system that drives a single reflective liquid crystal display in a time-sharing format. Further, by satisfying the optical conditions as outlined above, excellent picture quality may be realized.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A reflective liquid crystal display, comprising:
a semiconductor lower substrate;
a plurality of thin film transistors being included in said lower substrate;
a plurality of reflective electrodes being electrically connected to each of said transistors;
a transparent upper substrate opposing said lower substrate;
a plurality of common transparent electrodes being formed on a surface of said upper substrate opposing said reflective electrodes, said transparent electrodes forming pixels together with said reflective electrodes; and
a liquid crystal layer being formed between said lower substrate and said upper substrate, the following conditions being satisfied by the reflective liquid crystal display:
0.15≦(Δn*d)_{LC}(μm)≦0.25,
0.10≦Δn≦0.28,
where Δn is a difference between a refractive index of long axes of the liquid crystals of the liquid crystal layer and a refractive index of short axes of the liquid crystals of the liquid crystal layer, and where d is a cell gap of the reflective liquid crystal display.

2. The display of claim 1, said liquid crystal layer comprising nematic liquid crystals.

3. The display of claim 2, each one of said transistors comprising:
a first electrode of a principal electrically conducting channel;
a second electrode of the principal electrically conducting channel being connected to at least one of said reflective electrodes through at least one of the connecting electrodes, providing the voltage to said at least one of said reflective electrodes; and
a control electrode controlling electrical conduction on the principal electrically conducting channel;
said first electrode, second electrode, and control electrode being separated from each other by at least one insulating layer.

4. The display of claim 3, further comprising a capacitor being mounted between said control electrode and said lower substrate, said capacitor being separated from said first, second, and control electrodes by the at least one insulating layer.

5. A projection system, comprising:
a light converter sequentially converting white light emitted from a light source into first, second, and third light;
a polarizing beam splitter separating received light into S-polarized light and P-polarized light;
a reflective liquid crystal display including liquid crystals, said reflective liquid crystal display receiving the polarized light, said reflective liquid crystal display driving the liquid crystals for each pixel to display images;
a polarizing plate being mounted in a path of the polarized light, said polarizing plate selectively transmitting light of a specific polarizing axis;
a λ/4-plate being mounted on said reflective liquid crystal display, said λ/4-plate removing elliptical polarization of the polarized light; and
a retardation film being mounted to one surface of said λ/4-plate, said retardation film compensating a refractive index dispersion according to a wavelength of the liquid crystals, said reflective liquid crystal display satisfying the following conditions:
0.15≦(Δn*d)_{LC}(μm)≦0.25,
0.10≦Δn≦0.28,
where (Δn*d)_{LC} indicates a retardation of said reflective liquid crystal display, where Δn is a difference between a refractive index of long axes of the liquid crystals and a refractive index of short axes of the liquid crystals, and where d is a cell gap of said reflective liquid crystal display.

6. The system of claim 5, the liquid crystals included in said reflective liquid crystal display being nematic liquid crystals.

7. The system of claim 6, the liquid crystals included in said reflective liquid crystal display having a twist angle in the range of 0˜80°.

8. The system of claim 7, said polarizing plate having a polarizing axis, the polarizing axis of said polarizing plate and a rubbing axis of the liquid crystals forming an angle being in one range selected from among a first range of 0˜50° and a second range of 110˜170°.

9. The system of claim 8, said retardation film satisfying the following condition:
10≦(Δn*d)_{RF}≦200,
where (Δn*d)_{RF} is a retardation of said retardation film.

10. The system of claim 9, said retardation film having an optical axis angle in the range of 0˜180°.

11. The system of claim 5, said λ/4-plate being a wideband λ/4-plate removing the elliptical polarization of the polarized light in visible ray wavelength range.

12. A projection system, comprising:
a polarizing beam splitter separating received light into S-polarized light and P-polarized light;
a reflective liquid crystal display including liquid crystals, said reflective liquid crystal display receiving the polarized light from said polarizing beam splitter, said reflective liquid crystal display driving the liquid crystals for each pixel to display images;
a λ/4-plate being mounted between said polarizing beam splitter and said reflective liquid crystal display, said λ/4-plate removing elliptical polarization of the polarized light; and
a retardation film being mounted to one surface of said λ/4-plate, said retardation film compensating a refractive index dispersion according to a wavelength of the liquid crystals, said reflective liquid crystal display satisfying the following conditions:
0.15≦(Δn*d)LC(μm)≦0.25,
0.10≦Δn≦0.28,
where (Δn*d)_{LC} indicates a retardation of said reflective liquid crystal display, where Δn is a difference between a refractive index of long axes of the liquid crystals and a refractive index of short axes of the liquid crystals, and where d is a cell gap of said reflective liquid crystal display.

13. The system of claim 12, the liquid crystals included in said reflective liquid crystal display being nematic liquid crystals.

14. The system of claim 13, the liquid crystals included in said reflective liquid crystal display having a twist angle in the range of 0˜80°.

15. The system of claim 12, further comprising:
a polarizing plate being mounted in a path of the polarized light, said polarizing plate having a predetermined polarizing axis, said polarizing plate selectively transmitting light having the predetermined polarizing axis.

16. The system of claim 15, the predetermined polarizing axis of said polarizing plate and a rubbing axis of the liquid crystals forming an angle being in one range selected from among a first range of 0˜50° and a second range of 110˜170°.

17. The system of claim 12, said λ/4-plate being a wideband λ/4-plate removing the elliptical polarization of the polarized light in visible ray wavelength range.

18. The system of claim 12, said retardation film having an optical axis angle in the range of 0˜180°.

19. The system of claim 18, said retardation film satisfying the following conditions:
10≦(Δn*d)_{RF}≦200,
where (Δn*d)_{RF} is a retardation of said retardation film.

20. The system of claim 12, said retardation film satisfying the following conditions:
10≦(Δn*d)_{RF}≦200,
where (Δn*d)_{RF} is a retardation of said retardation film.

21. The system of claim 20, the liquid crystals included in said reflective liquid crystal display being nematic liquid crystals.

22. The system of claim 21, the liquid crystals included in said reflective liquid crystal display having a twist angle in the range of 0˜80°.

23. A reflective liquid crystal display, comprising:
a semiconductor lower substrate;
a plurality of thin film transistors being included in said lower substrate;
a plurality of reflective electrodes being electrically connected to each of said transistors;
a transparent upper substrate opposing said lower substrate;
a plurality of common transparent electrodes being formed on a surface of said upper substrate opposing said reflective electrodes, said transparent electrodes forming pixels together with said reflective electrodes; and
a liquid crystal layer being formed between said lower substrate and said upper substrate, the following conditions being satisfied by the reflective liquid crystal display:
0.15≦(Δn*d)_{LC}(μm)≦0.25,
0.10≦Δn≦0.28,
where Δn is a difference between a refractive index of long axes of the liquid crystals of the liquid crystal layer and a refractive index of short axes of the liquid crystals of the liquid crystal layer, and where d is a cell gap of the reflective liquid crystal display, the liquid crystals having a twist angle in the range of 0˜80°.

24. A projection system, comprising:
a light converter sequentially converting white light emitted from a light source into first, second, and third light;
a polarizing beam splitter separating received light into S-polarized light and P-polarized light;
a reflective liquid crystal display including liquid crystals, said reflective liquid crystal display receiving the polarized light from said polarizing beam splitter, said reflective liquid crystal display driving the liquid crystals for each pixel to display images;
a polarizing plate being mounted in a path of the polarized light, said polarizing plate selectively transmitting light of a specific polarizing axis, said polarizing plate having a polarizing axis, the polarizing axis and a rubbing axis of the liquid crystals forming a rubbing axis angle being in one range selected from among a first range of 0˜50° and a second range of 110˜170°;
a λ/4-plate being mounted between said polarizing beam splitter and said reflective liquid crystal display, said λ/4-plate removing elliptical polarization of the polarized light; and
a retardation film being mounted to one surface of said λ/4-plate, said retardation film compensating a refractive index dispersion according to a wavelength of the liquid crystals, said reflective liquid crystal display satisfying the following conditions:
0.15≦(Δn*d)_{LC}(μm)≦0.25,
0.10≦Δn≦0.28,
where (Δn*d)_{LC} indicates a retardation of said reflective liquid crystal display, where Δn is a difference between a refractive index of long axes of the liquid crystals and a refractive index of short axes of the liquid crystals, and where d is a cell gap of said reflective liquid crystal display, the liquid crystals having a twist angle in the range of 0˜80°.
